(19) United States
(12) Patent Application Publication
(10) Pub. No.: US 2012/0170868 A1
(43) Pub. Date: Jul. 5, 2012

(54) IMAGE MANAGEMENT METHOD OF DIGITAL PHOTOGRAPHY DEVICE

(75) Inventor: Feng-Hsing Wang, Tainan City (TW)

(73) Assignee: ALTEK CORPORATION, Hsinchu City (TW)

(21) Appl. No.: 13/158,478

(22) Filed: Jun. 13, 2011

(30) Foreign Application Priority Data
Dec. 31, 2010 (TW) 99147246

(51) Int. Cl. G06K 9/54

(52) U.S. Cl. 382/305

(57) ABSTRACT

An image management method of a digital photography device including the followed steps is provided. Firstly, a digital image is captured according to a capturing instruction. Next, the digital image is analyzed to determine whether the digital image is successful or not. If the digital image is analyzed as a failed image, the digital image is stored in a specific folder. If the digital image is analyzed as a successful image, the digital image is stored in a playback folder. Thus, the digital images of the digital photography device can be efficiently managed.

### CROSS-REFERENCE TO RELATED APPLICATION

This application claims the priority benefit of Taiwan application serial no. 99147246, filed Dec. 31, 2010. The entirety of the above-mentioned patent application is hereby incorporated by reference herein and made a part of this specification.

### BACKGROUND OF THE INVENTION

1. Field of the Invention

The present invention generally relates to an image management method, in particular, to an image management method of a digital photography device.

2. Description of Related Art

Along with the development of the technology, human has gradually increasing dependence on electronic products. To meet the requirements of current consumers on electronic products as having high speed, high performance, being light, thin, short, and small, and being easily portable, various portable electronic devices, such as notebook PCs, cell phones, personal digital assistants (PDAs), and digital cameras, are not only mainstream products available in the market, but also indispensable application tools in modern people's life and work.

In order to record details of life, portable electronic devices having digital camera functions are more and more popular. For example, cell phones and PDAs are also built in with digital camera functions. Users are able to take pictures conveniently using the digital photography devices, and store images of digital formats in storage devices such as memory cards. Generally, a user needs to insert the memory card into a computer, and actions such as classification, renaming, deletion, and edition are executed through specific picture management software installed in the computer. Alternatively, the pictures are viewed one by one to determine whether the pictures are successful or not through a viewing and amplifying function built in the digital camera, and the failed pictures are deleted manually.

However, the capacity of the memory card becomes larger, and thus the number of pictures that can be stored in the memory card becomes larger as well. Therefore, how to arrange picture files of a huge number in the memory card is a common problem followed.

### SUMMARY OF THE INVENTION

Accordingly, the present invention is directed to an image management method of a digital photography device, which is able to manage pictures conveniently and efficiently.

The present invention provides an image management method of a digital photography device, which includes the following steps. A digital image is captured according to a capturing instruction. The digital image is analyzed to determine whether the digital image is successful or not. If the digital image is analyzed as a failed image, the digital image is stored in a specific folder. If the digital image is analyzed as a successful image, the digital image is stored in a playback folder.

According to an embodiment of the present invention, the image management method of a digital photography device further includes the following steps. Digital images stored in the playback folder are read according to a user instruction. The digital images stored in the playback folder are analyzed to determine whether the digital images are successful or not. Digital images analyzed as failed images are moved to the specific folder.

According to an embodiment of the present invention, in the image management method of a digital photography device, the step of analyzing the digital images stored in the playback folder to determine whether the digital images are successful or not includes the following steps. At least one of a plurality of filtering conditions selected by a user is received by using a user interface. According to the at least one filtering condition, the digital images stored in the playback folder are analyzed to determine whether the digital images are successful or not.

According to an embodiment of the present invention, the image management method of a digital photography device further includes the following step. If the digital image is analyzed as a failed image, the digital image is displayed and a message that the digital image is a failed image is prompted.

According to an embodiment of the present invention, the image management method of a digital photography device further includes the following step. If the digital image is analyzed as a failed image, failure state information of the digital image is recorded.

According to an embodiment of the present invention, in the image management method of a digital photography device, the step of recording the failure state information includes writing the failure state information in a text file.

According to an embodiment of the present invention, before the step of analyzing the digital image to determine whether the digital image is successful or not, the image management method of a digital photography device further includes the following steps. According to a user instruction, the step of analyzing the digital image to determine whether the digital image is successful or not is disabled. The digital image is stored in the playback folder.

According to an embodiment of the present invention, the image management method of a digital photography device further includes starting a preset playback function according to a user instruction, so as to play digital images stored in the playback folder.

According to an embodiment of the present invention, the image management method of a digital photography device further includes playing digital images stored in the specific folder according to a user instruction.

According to an embodiment of the present invention, the image management method of a digital photography device further includes moving at least one of digital images stored in the specific folder to the playback folder according to a user instruction.

According to an embodiment of the present invention, in the image management method of a digital photography device, the step of analyzing the digital image to determine whether the digital image is successful or not includes the following steps. At least one of a plurality of filtering conditions selected by a user is received by using a user interface. According to the at least one filtering condition, the digital image is analyzed to determine whether the digital image is successful or not.

In view of the above, according to the image management method of the digital photography device in the present invention, after capturing the digital image, the digital image is analyzed automatically to determine whether the digital image is successful or not, and the digital image analyzed as a successful image and the digital image analyzed as a failed image are stored in a playback folder and a specific folder respectively. Therefore, actions and time for the user to manually determine whether the digital image is successful or not are greatly reduced.

In order to make the aforementioned features and advantages of the present invention comprehensible, embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the present invention.

FIG. 1 is a flow chart of an image management method of a digital photography device according to a first embodiment of the present invention.

FIG. 2 is a flow chart of an image management method of a digital photography device according to a second embodiment of the present invention.

FIG. 3 is a schematic view of a user interface in FIG. 2.

FIG. 4 is a flow chart of an image management method of a digital photography device according to a third embodiment of the present invention.

FIG. 5 is a flow chart of an image management method of a digital photography device according to a fourth embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

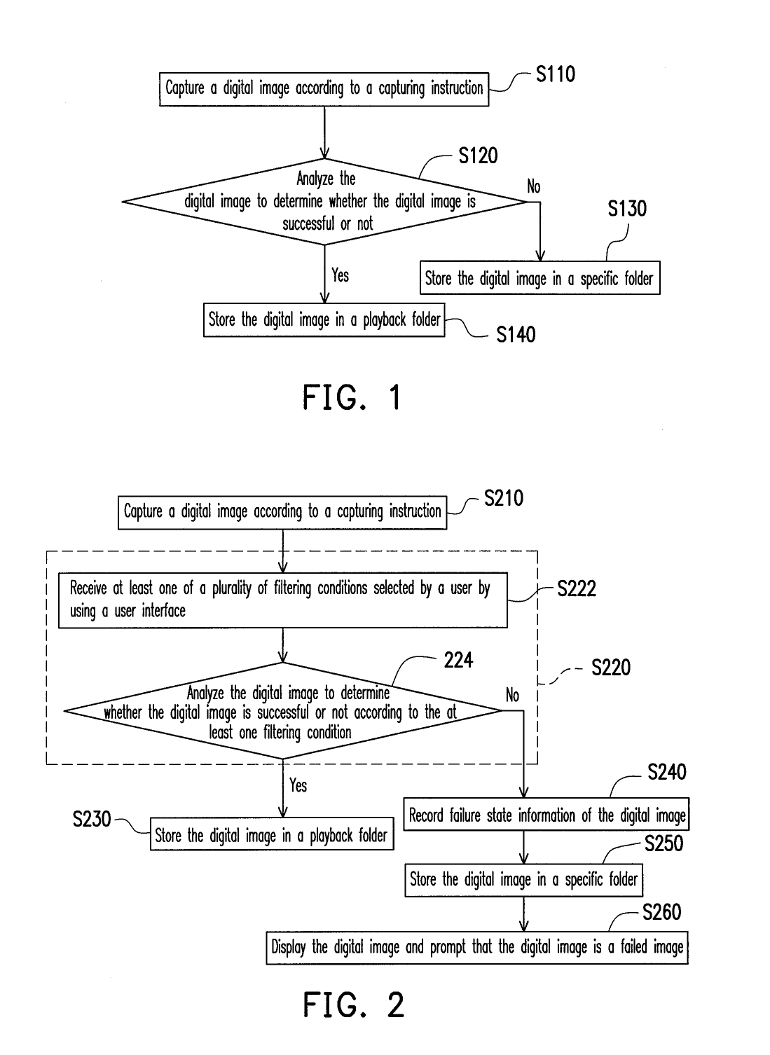

FIG. 1 is a flow chart of an image management method of a digital photography device according to a first embodiment of the present invention, in which the digital photography device is, for example, but not limited to, a digital camera. Referring to FIG. 1, Step S110 is performed first, in which a digital image is captured according to a capturing instruction. For example, when a user presses a shutter button of the digital photography device, a capturing instruction is thus triggered, such that the digital photography device captures a digital image according to shutter time, aperture setting, and the like.

Then, Step S120 is performed, in which the digital image is analyzed to determine whether the digital image is successful or not. Particularly, whether the digital image is successful or not may be determined according to conditions such as whether the digital image is blurred, whether overexposure/underexposure occurs, whether only half of a face is shot, whether going beyond the anti-shake ability, and whether there is a smile or blink. The conditions for determination may be implemented through technologies such as blur detection, contrast detection, human face recognition, human body proportion detection, and composition proportion detection.

If the digital image is analyzed as a failed image, Step S130 is performed, in which the digital image is stored in a specific folder. That is to say, if the digital image is too blurred or only half of a face is shot, the digital image is automatically stored in the specific folder. On the contrary, if the digital image is analyzed as a successful image, Step S140 is performed, in which the digital image is stored in a playback folder. When the user presses a view playback button of the digital photography device, it is preset that digital images of the playback folder are played. That is to say, during the playback, the user cannot determine digital images in the specific folder. Moreover, the digital photography device may provide an option of playing the specific folder, so as to play the digital images stored in the specific folder.

It should be noted that, after the digital photography device captures the digital image, the digital image is analyzed automatically, and the successful digital image and failed digital image are put in the playback folder and the specific folder respectively. Therefore, actions and time for the user to manually determine whether the digital image is successful or not are greatly reduced.

FIG. 2 is a flow chart of an image management method of a digital photography device according to a second embodiment of the present invention. Referring to FIG. 2, for ease of illustration, steps in this embodiment similar to those in the above embodiment are not repeated. First, Step S210 is performed, in which a digital image is captured according to a capturing instruction. The, Step S220 is performed, in which the digital image is analyzed to determine whether the digital image is successful or not. In this embodiment, Step S220 may include two sub-steps, that is, Steps S222 and S224.

FIG. 3 is a schematic view of a user interface in FIG. 2. Referring to FIGS. 2 and 3, Step S222 is performed first, in which at least one of a plurality of filtering conditions selected by a user is received by using a user interface 50. For example, the user interface 50 may provide options such as “blurred”, “overexposure/underexposure”, and “beyond anti-shake ability”, for the user to select. After the user completes the selection, a pattern of “Confirm” may be clicked, or “Cancel” is clicked to give up the current selection. Then, Step S224 is performed, in which the digital image is analyzed to determine whether the digital image is successful or not according to the at least one filtering condition. In this embodiment, when the digital photography device analyzes that the captured digital image is blurred or the case of going beyond the anti-shake ability occurs at the instant of pressing the shutter, the digital image is determined as a failed image.

If the digital image is analyzed as a successful image, Step S230 is performed, in which the digital image is stored in a playback folder. On the contrary, if the digital image is analyzed as a failed image, Step S240 is performed, in which failure state information of the digital image is recorded. In this embodiment, the failure state information may be written in a text file. For example, the text file records reasons why the digital images in the specific folder are determined as failed images, for the reference of the user. Alternatively, the digital photography device performs simple post-process on the digital image automatically according to the reasons recorded in the text file. For example, when the digital image is determined as a failed image due to blur, the size of the digital image may be reduced automatically; when the digital image is determined as a failed image due to overexposure/underexposure, the brightness and contrast of the digital image may be adjusted automatically, and the like. Moreover, the failure state information may also be stored in an exchangeable image file format (EXIF) of each digital image, but the present invention is not limited thereto.

Then, Step S250 is performed, in which the digital image is stored in a specific folder. Thereafter, Step S260 is performed, in which the digital image is displayed, and a message that the digital image is a failed image is prompted. That is to say, after the digital photography device captures the failed digital image, in addition to showing the digital image on a screen, a message is also prompted, such that the user is aware that the digital image is a failed digital image. At this time, the user may capture the digital image once again according to the prompt, without the process of manually amplifying and viewing the digital image to determine whether the digital image is successful or not. Therefore, the time for the photographed to wait is further reduced.

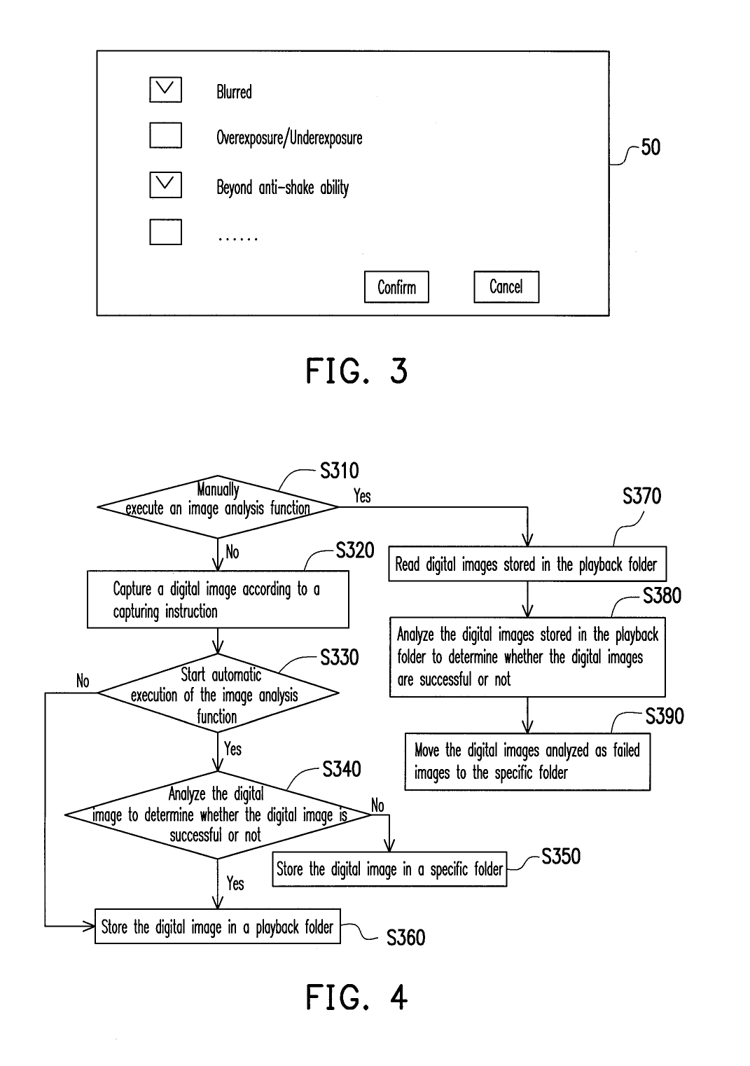

FIG. 4 is a flow chart of an image management method of a digital photography device according to a third embodiment of the present invention. Referring to FIG. 4, for ease of illustration, steps in this embodiment similar to those in the above embodiment are not repeated. First, Step S310 is performed, in which it is determined whether the step of manually executing an image analysis function is performed or not. Particularly, the digital photography device may provide an option of manually executing the image analysis function. When the user selects to manually execute the image analysis function (equivalent to a user instruction), Step S370 is performed, in which digital images stored in the playback folder are read. Then, Step S380 is performed, in which the digital images stored in the playback folder are analyzed to determine whether the digital images are successful or not. In this embodiment, Step S380 may be performed in a manner similar to Step S220 of FIG. 2. That is to say, at least one of a plurality of filtering conditions selected by the user may be received by using the user interface 50 of FIG. 3. Then, the digital images stored in the playback folder are analyzed to determine whether the digital images are successful or not according to the filtering condition selected by the user. Thereafter, Step S390 is performed, in which the digital images analyzed as failed images are moved to the specific folder.

On the contrary, if the user does not select to manually execute the image analysis function, but presses a shutter button (equivalent to a capturing instruction), Step S320 is performed, in which a digital image is captured. Then, Step S330 is performed, in which it is determined whether to start automatic execution of the image analysis function. Particularly, the digital photography device may provide options of starting and closing the automatic execution of the image analysis function. If the user starts the automatic execution of the image analysis function, Step S340 is performed, in which the digital image is analyzed to determine whether the digital image is successful or not. If the digital image is analyzed as a failed image, Step S350 is performed, in which the digital image is stored in a specific folder. On the contrary, if the digital image is analyzed as a successful image, Step S360 is performed, in which the digital image is stored in a playback folder. However, if the user selects the option of closing the automatic execution of the image analysis function (equivalent to a user instruction), Step S340 of analyzing the digital image to determine whether the digital image is successful or not is disabled, and the digital image is stored in the playback folder (Step S360).

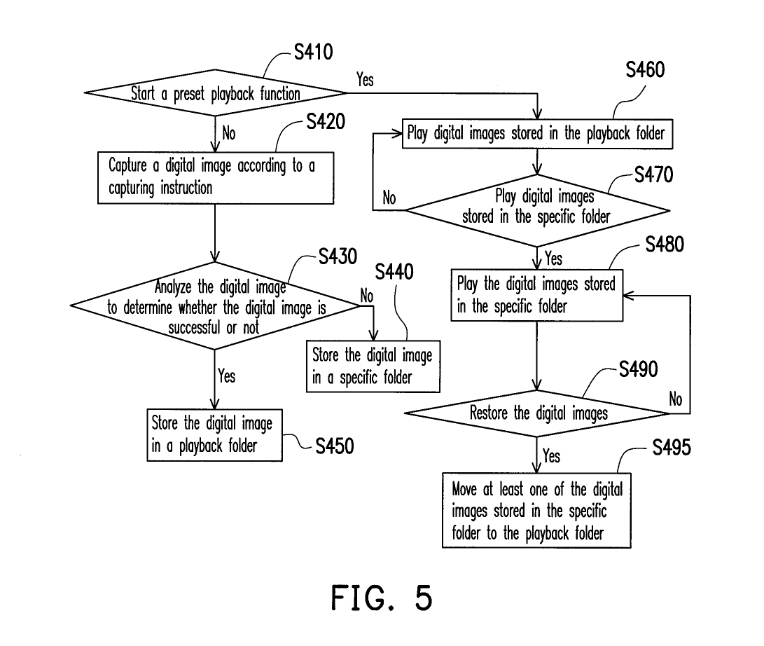

FIG. 5 is a flow chart of an image management method of a digital photography device according to a fourth embodiment of the present invention. Referring to FIG. 5, for ease of illustration, steps in this embodiment similar to those in the above embodiment are not repeated. First, Step S410 is performed, in which it is determined whether a preset playback function is started or not. When the user presses a view playback button of the digital photography device (equivalent to a user instruction), the preset playback function is started. At this time, Step S460 is performed, in which digital images stored in the playback folder are played. Then, Step S470 is performed, in which it is determined whether digital images stored in the specific folder are played or not. Particularly, the digital photography device may provide an option of playing the specific folder. When the user selects the option of playing the specific folder, Step S480 is performed, in which the digital images stored in the specific folder are played.

Then, Step S490 is performed, in which it is determined whether the digital images are restored or not. In this embodiment, the digital photography device may provide an option of restoring the digital images. If the user considers that one or more digital images in the specific folder should not be classified as failed images, the option of restoring the digital images may be selected (equivalent to a user instruction). At this time, Step S495 is performed, in which at least one of the digital images stored in the specific folder is moved to the playback folder. That is to say, the digital photography device can restore the digital images to the playback folder storing pictures analyzed as successful pictures, according to the selection instruction of the user. Moreover, the digital photography device may also provide an option of deleting the digital images, such that the user can select to delete a single digital image or all the digital images in the specific folder.

On the contrary, if the user does not start the preset playback function, but presses the shutter button, Step S420 is performed, in which a digital image is captured. Then, Step S430 is performed, in which the digital image is analyzed to determine whether the digital image is successful or not. If the digital image is analyzed as a failed image, Step S440 is performed, in which the digital image is stored in a specific folder. On the contrary, if the digital image is analyzed as a successful image, Step S450 is performed, in which the digital image is stored in a playback folder.

In view of the above, according to the image management method of the digital photography device of the present invention, after capturing the digital image, the digital image is analyzed automatically to determine whether the digital image is successful or not, and the digital image is stored in a corresponding folder according to a result of the analysis. Therefore, actions and time for the user to manually determine whether the digital image is successful or not are greatly reduced. Moreover, the present invention further provides a user interface to receive the filtering condition selected by the user, so as to analyze the digital image to determine whether the digital image is successful or not according to the selected filtering condition. Therefore, requirements of different users may be better satisfied, thus being more humanized. In addition, the present invention can record state information of failed digital images, so as to help the user to judge the state of the picture. Further, if the analysis result is inconsistent with the expectation of the user, the user may also restore the images analyzed as failed images to the playback folder.

It will be apparent to those skilled in the art that various modifications and variations can be made to the structure of the disclosed embodiments without departing from the scope or spirit of the present invention. In view of the foregoing, it is intended that the present invention cover modifications and variations of this present invention provided they fall within the scope of the following claims and their equivalents.

What is claimed is:

1. An image management method of a digital photography device, comprising:
capturing a digital image according to a capturing instruction;
analyzing the digital image to determine whether the digital image is successful or not;
if the digital image is analyzed as a failed image, storing the digital image in a specific folder; and
if the digital image is analyzed as a successful image, storing the digital image in a playback folder.

2. The image management method of a digital photography device according to claim 1, further comprising:
reading digital images stored in the playback folder according to a user instruction;
analyzing the digital images stored in the playback folder to determine whether the digital images are successful or not; and
moving digital images analyzed as failed images to the specific folder.

3. The image management method of a digital photography device according to claim 2, wherein the step of analyzing the digital images stored in the playback folder to determine whether the digital images are successful or not comprises:
receiving at least one of a plurality of filtering conditions selected by a user by using a user interface; and
analyzing the digital images stored in the playback folder to determine whether the digital images are successful or not according to the at least one filtering condition.

4. The image management method of a digital photography device according to claim 1, further comprising:
if the digital image is analyzed as a failed image, displaying the digital image and prompting a message that the digital image is a failed image.

5. The image management method of a digital photography device according to claim 1, further comprising:
if the digital image is analyzed as a failed image, recording failure state information of the digital image.

6. The image management method of a digital photography device according to claim 5, wherein the step of recording the failure state information comprises:
writing the failure state information in a text file.

7. The image management method of a digital photography device according to claim 1, wherein before the step of analyzing the digital image to determine whether the digital image is successful or not, the method further comprises:
disabling the step of analyzing the digital image to determine whether the digital image is successful or not according to a user instruction; and
storing the digital image in the playback folder.

8. The image management method of a digital photography device according to claim 1, further comprising:
starting a preset playback function according to a user instruction, so as to play digital images stored in the playback folder.

9. The image management method of a digital photography device according to claim 1, further comprising:
playing digital images stored in the specific folder according to a user instruction.

10. The image management method of a digital photography device according to claim 1, further comprising:
moving at least one of digital images stored in the specific folder to the playback folder according to a user instruction.

11. The image management method of a digital photography device according to claim 1, wherein the step of analyzing the digital image to determine whether the digital image is successful or not comprises:
receiving at least one of a plurality of filtering conditions selected by a user by using a user interface; and
analyzing the digital image to determine whether the digital image is successful or not according to the at least one filtering condition.
